(19) United States
(12) Patent Application Publication
(10) Pub. No.: US 2023/0244450 A1
(43) Pub. Date: Aug. 3, 2023

(54) Integrated Circuit for Generating Random Vectors

(71) Applicant: Infineon Technologies AG, Neubiberg (DE)

(72) Inventors: Rainer Göettfert, Putzbrunn (DE); Gerd Dirscherl, München (DE); Berndt Gammel, Markt Schwaben (DE)

(21) Appl. No.: 18/104,550

(22) Filed: Feb. 1, 2023

(30) Foreign Application Priority Data
Feb. 3, 2022 (DE) 102022102594.2

(51) Int. Cl. G06F 7/58; G06F 17/16

(52) U.S. Cl. CPC G06F 7/588; G06F 17/16

(57) ABSTRACT

According to one exemplary embodiment, an integrated circuit is described, comprising multiple noise sources, each noise source being configured to output a respective set of noise bits for a random vector, a combinational logic circuit configured to process a noise bit vector, corresponding to a concatenation of the bits of the sets of noise bits, in accordance with a multiplication by a matrix to produce a processed noise bit vector, with the result that the processed noise bit vector comprises more bits than each of the sets of noise bits and comprises fewer bits than the noise bit vector; and a post-processing logic circuit configured to generate the random vector from the processed noise bit vector.

### TECHNICAL FIELD

The present disclosure relates to integrated circuits for generating random vectors.

### BACKGROUND

Random numbers are used for various applications in data processing devices. Some of these applications are security-relevant, such as when a random key is meant to be generated for a cryptographic operation. Accordingly, there are high demands on the random numbers generated for such applications, in particular with respect to the entropy of said random numbers. To ensure that random numbers generated by a random number generator have sufficient entropy, there can be provision for the random number generator to contain multiple noise sources in order to generate random numbers. Random numbers are typically also meant to be generated at as high a rate as possible in this case.

Integrated circuits for generating random vectors are therefore wanted that generate random vectors having high entropy efficiently on the basis of multiple noise sources.

### SUMMARY

According to one embodiment, an integrated circuit is provided, comprising multiple noise sources, each noise source being configured to output a respective set of noise bits for a random vector The integrated circuit further comprises a combinational logic circuit configured to process a noise bit vector, corresponding to a concatenation of the bits of the sets of noise bits, in accordance with a multiplication by a matrix to produce a processed noise bit vector, with the result that the processed noise bit vector comprises more bits than each of the sets of noise bits and comprises fewer bits than the noise bit vector, as well as a post-processing logic circuit configured to generate the random vector from the processed noise bit vector.

### BRIEF DESCRIPTION OF THE FIGURES

The figures do not reproduce the actual size ratios but rather are intended to be used to illustrate the principles of the different exemplary embodiments. The text below describes various exemplary embodiments with reference to the figures below.

FIG. 1 shows an example of an electronic data processing device.

FIG. 2 illustrates a first approach for supplying noise bits generated by multiple noise sources to a post-processing logic circuit.

FIG. 3 illustrates a second approach for supplying noise bits generated by multiple noise sources to a post-processing logic circuit.

FIG. 4 shows a random number generator according to one embodiment.

FIG. 5 shows a random number generator having an adjustable robustness level according to one embodiment.

FIG. 6 shows an integrated circuit according to one embodiment.

FIG. 7 shows a flowchart that illustrates a method for generating a random vector according to one embodiment.

### DETAILED DESCRIPTION

The detailed description below relates to the accompanying figures, which show details and exemplary embodiments. These exemplary embodiments are described in such detail that a person skilled in the art is able to carry out the invention. Other embodiments are also possible and the exemplary embodiments can be modified in structural, logical and electrical respects without departing from the subject matter of the invention. The different exemplary embodiments are not necessarily mutually exclusive, but rather different embodiments can be combined with one another so that new embodiments are formed. This description uses the terms “connected” and “coupled” to describe both a direct and an indirect connection and a direct or indirect coupling.

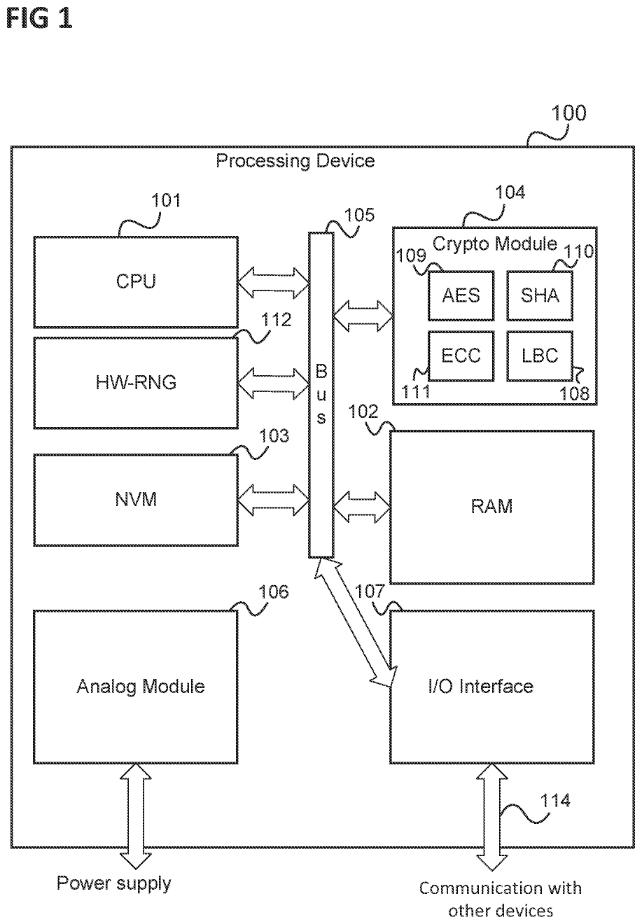

FIG. 1 shows an example of a processing device 100 having a CPU 101, a RAM (Random Access Memory) 102, a nonvolatile memory 103 (NVM), a crypto module 104, an analog module 106, an input/output interface 107 and a hardware random number generator 112 (HW-RNG).

In this example, the CPU 101 has access to at least one crypto module 104 via a common bus 105, to which each crypto module 104 is connected. Each crypto module 104 can comprise in particular one or more crypto cores in order to perform specific cryptographic operations. Illustrative crypto cores are:
an AES core 109,
an SHA core 110,
an ECC core 111, and
a lattice-based crypto (LBC) core 108.

The CPU 101, the hardware random number generator 112, the NVM 103, the crypto module 104, the RAM 102 and the input/output interface 107 are connected to the bus 105. The input/output interface 107 can have a connection 114 for communication with other devices similar to the processing device 100.

The bus 105 itself can be masked or simple. Instructions for executing the processing and the algorithms described below can be in particular stored in the NVM 103 and processed by the CPU 101. The processed data can be stored in the NVM 103 or in the RAM 102. Random numbers are delivered by the hardware random number generator 112.

The processing and the algorithms described below can be executed exclusively or at least in part on the crypto module 104. Alternatively, they can be carried out by the CPU 101, and a dedicated crypto module 104 can be dispensed with.

The components of the processing device 100 can be implemented on a single chip or on multiple chips. The processing device 100 can be a chip card (or a chip card module) that is supplied with power by way of direct electrical contact or by way of an electromagnetic field. The processing device 100 can be a fixed circuit or can be based on reconfigurable hardware (e.g. field programmable gate array, FPGA). The processing device 100 can be connected to a personal computer, microcontroller, FPGA or to a smartphone system on a chip (SoC) or on other components of a smartphone. The processing device 100 can be a chip that acts as a trusted platform module (TPM) and provides cryptographic functionality according to a standardized interface to a computer, a smartphone, an Internet of Things (IoT) device or a vehicle. Alternatively, the processing device 100 can itself be a standalone data processing device, e.g. a personal computer, a smartphone, a chip card (having any form factor), etc.

Like the processing device 100, which comprises the hardware random number generator 112, many information technology (IT) products contain random number generators (RNGs). Random number generators play an important role in cryptographic applications. The quality of the random numbers generated in this case typically needs to comply with various national standards.

A random number generator for “true” random numbers (TRNG, for true RNG) typically consists of a physical noise source (NS), which generates noise data (or raw data), and a downstream mathematical post-processing circuit, which compresses the generated raw data and in this way increases the per-bit entropy of the random numbers generated (compared to the raw data) (i.e., the post-processed random numbers contain more entropy per bit than the raw data).

In recent years, it is possible to identify a trend of implementing not just one physical noise source in an IT product but rather multiple. One reason for this is that international standards require or recommend the use of multiple noise sources for generating random numbers. Another reason is that innovations in the design of random number generators in recent years allow noise sources having little hardware surface area (low gate count) and correspondingly low power consumption to be built in semiconductor technology. The hardware costs of a physical noise source are then only a fraction of the hardware costs for the mathematical and/or cryptographic post-processing. It is therefore possible to use multiple physical noise sources in conjunction with a single post-processing algorithm without thereby substantially increasing the total surface area of the random number generator (and hence without substantially increasing the total costs of the random number generator).

It is assumed for the examples below that each noise source produces one m-bit word per unit time (e.g., per CPU clock cycle), where m≥1 is an integer. (The special case m=1 corresponds to the frequently encountered case in which the physical noise source generates one bit per unit time.) There will be provision for a total of q≥2 such noise sources for a random number generator (e.g. HW-RNG 112). Therefore, n=mq noise bits (random raw bits) are generated per unit time.

These n=mq noise bits are supplied to a post-processing algorithm (which is carried out to by a post-processing logic circuit of the random number generator).

This raises the question of how the arising n=mq noise bits are meant o be supplied to the post-processing logic circuit.

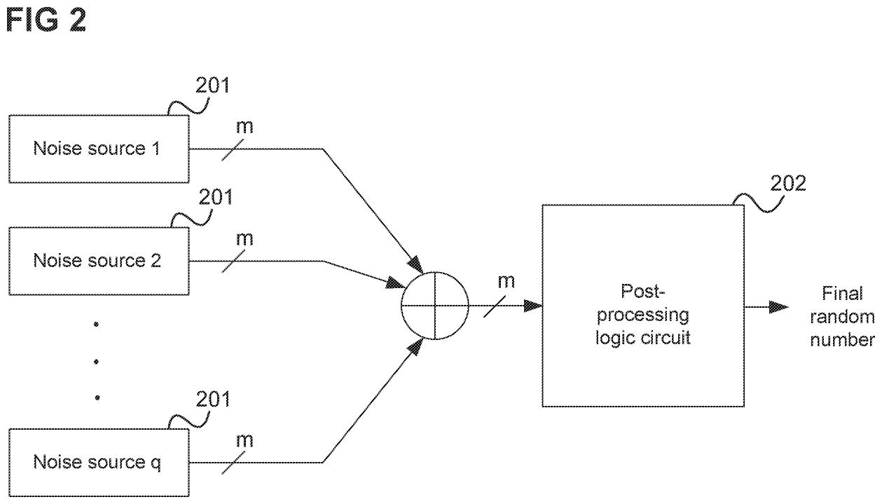

FIG. 2 illustrates a first approach for supplying noise bits generated by multiple noise sources 201 to a post-processing logic circuit 202.

The m-bit random words W₁, W₂, . . . , W_{q} generated by the q noise sources 201 are XORed bit by bit. The XOR sum

W=W₁⊕W₂⊕ . . . ⊕W_{q},

which is also an m-bit word, represents the input for the mathematical (or cryptographic post-processing circuit 202.

The “⊕” in the above sum means bit-by-bit XOR of the m-bit words W₁, . . . , W_{q}. When m=3, for example (1,1,0)⊕(1,0,0)=(0,1,0)].

Since the q noise sources 201 generate their noise bits independently of one another, the random words W₁, . . . , W_{q} produced are statistically independent. The combined word W contains at least as much entropy as every single one of the q words W₁, . . . , W_{q}, and normally contains even a higher entropy than the individual words.

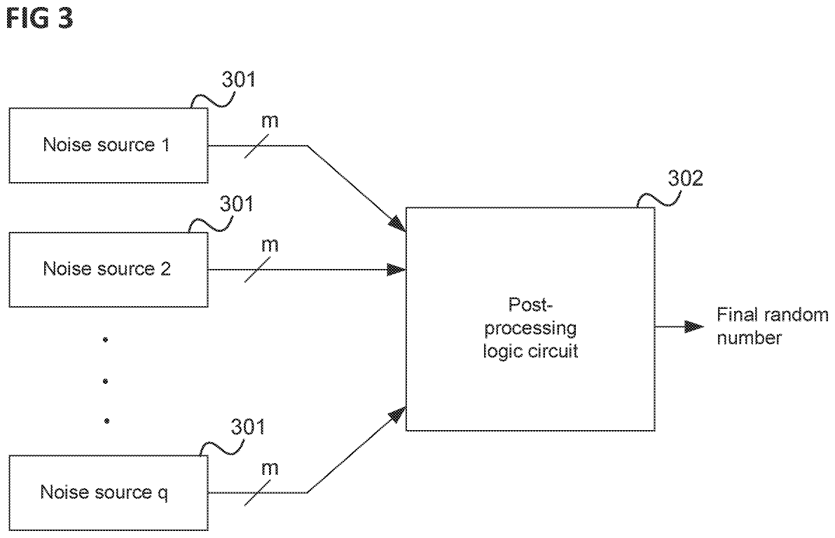

FIG. 3 illustrates a second approach for supplying noise bits generated by multiple noise sources 301 to a post-processing logic circuit 302.

The q random words of length m generated by the noise sources 301 per unit time are concatenated to produce a random word

Z=(W₁, W₂, . . . , W_{q}).

The n=mq-bit random word Z is supplied to the post-processing logic circuit 302 within a unit of time.

The approach from FIG. 2 achieves a strong safety cushion. One or more noise sources 201 can be disabled or one or more noise sources can be interfered with, or controlled (in part or in full), by an attacker without a security problem arising. Provided that there is at least one noise source that remains intact, the final random numbers delivered by the random number generator are of high quality. Only if all q noise sources are affected does a security problem arise.

With the approach in FIG. 3, n=mq noise bits per unit time are channeled into the post-processing logic circuit 302, since every single noise source 301 produces in noise bits per unit time and a total of q noise sources are in operation simultaneously. With this approach, the final random data are thus generated q times faster (compared to a random number generator having only one physical noise source). The q simultaneously operated noise sources 301 increase the data rate for the final random numbers by the factor q.

The approach from FIG. 3 is used primarily for expedited generation of the final random numbers—and less for boosting security. This method is advantageous for devices that need to have lower demands either on failsafety (operational safety, safety applications) or on robustness against physical attacks (information security, security applications).

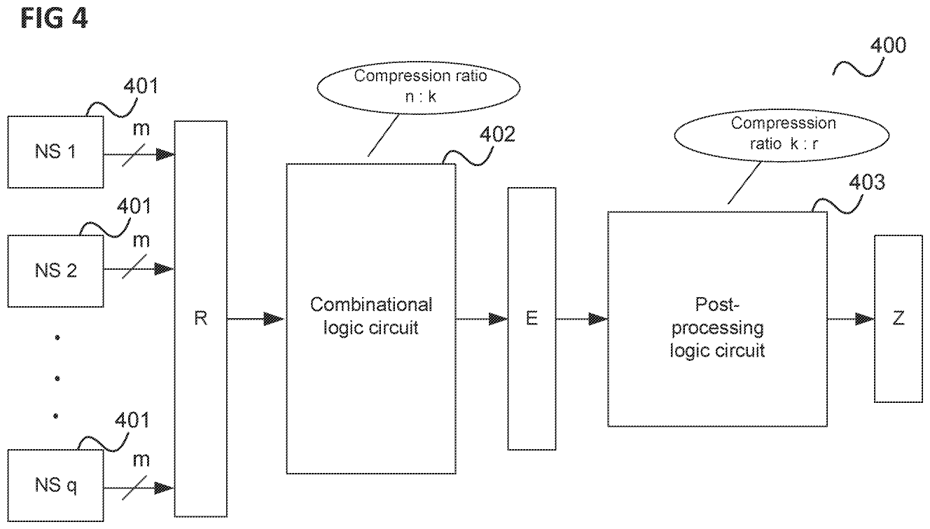

The approaches from FIG. 2 and FIG. 3 are extreme cases of a general approach that is shown in FIG. 4.

FIG. 4 shows a random number generator 400 having multiple noise sources 401, a combinational logic circuit 402 operating in accordance with a combinational logic algorithm and a post-processing logic circuit 403 operating in accordance with a post-processing algorithm (i.e. having one or more circuits that implement the combinational logic algorithm and the post-processing algorithm).

The random number generator has q≥2 independent noise sources 401. Each noise source 401 generates one m-bit random word m≥1) per unit time, with the result that n=mq noise bits R₁, R₂, . . . , Rₙ are generated per unit time. k derived noise bits E₁, E₂, . . . , Eₖ are formed from the n original noise bits R₁, R₂, . . . , Rₙ, and the vector E=(E₁, E₂, . . . , Eₖ) is input into the post-processing logic circuit 403 in one go (i.e., to generate a random number Z), where m≤k≤n.

With the approach from FIG. 2, k=m.

With the approach from FIG. 3, k=n=mq.

These two cases k=m and k=n are extreme cases.

According to various embodiments, a random number generator 400 is used for which m<k<n. When multiple noise sources are used, these “average” cases permit both an increase in security and an increase in throughput (i.e., the rate (length per unit time) at which the random number generator outputs random numbers).

If k<n, the conversion from R=(R₁, R₂, . . . , Rₙ) to E=(E₁, E₂, . . . , Eₖ) already results in a first data compression taking place. The effect of the data compression is that the entropy is compressed. That is to say that the derived random vector E generally has a higher per-bit entropy than the original random vector R. (Should R already contain 100% entropy then E would likewise have 100% entropy.)

The random vector E itself is compressed further by the post-processing logic circuit 403 to produce the final random number Z=(Z₁, Z₂, . . . , Zᵣ) of length r, where r<k. This second data compression results in a further compression of the entropy taking place. Particularly on the basis of this second data compression, the effect achieved is that the final random number generated then contains almost 100% entropy (and is therefore no longer distinguishable from a true random number). There can also be provision for the final random number to receive less than 100% entropy. By way of example, a lower entropy is already adequate in the event of randomization as a side channel countermeasure.

Generating the n noise bits R₁, R₂, . . . , Rₙ using the q simultaneously operating noise sources 401, combining them by means of the combinational logic circuit 402 to produce the k input bits EE₁, E₂, . . . , Eₖ and inputting these (in parallel) into the post-processing logic circuit 403 can be accomplished within one CPU clock cycle. Generation of the r output bits Z₁, Z₂, . . . , Zᵣ, or of the final random number Z=(Z₁, Z₂, . . . . , Zᵣ), can require multiple CPU clock cycles. This is dependent on the compression rate k:r of the post-processing logic circuit 403.

The precise value of the compression rate of the post-processing logic circuit 403 is dependent both on the entropy of the raw data and on the desired entropy of the final random numbers. if for example the random numbers output by the random number generator 400 (i.e. the “final” random numbers Z) contain at least 99.7% Shannon entropy and it will be assumed that the raw data generated by the noise sources 401 have only 50% entropy, then a compression rate of at least 10:1 would be required in order to get the compressed (i.e. the final) random numbers to contain at least 99.7% entropy. There are efficient post-processing algorithms (e.g., based on the von-Neumann algorithm, the Peres algorithm or on linear shift registers (LFSRs)) that produce output data having over 99.7% entropy from input data having 50% entropy at the compression rate 10:1.

It is typically desirable for a random number generator 400 containing multiple noise sources 401 to continue to deliver random numbers of the required quality even if some of these noise sources 401 fail.

As above, the random number generator 400 contains q≥2 noise sources 401. if b is assumed to be an integer where 0≤b≤q−1, then it is subsequently stated that the random number generator 400 has the robustness level b if the final random numbers still have the required entropy after failure of up to b noise sources.

With q noise sources 401 each generating one m-bit word per unit time, a total of n=mq noise bits R₁, . . . , Rₖₙ are generated per unit time. As explained above, these n noise bits are converted into k input bits E₁, . . . , Eₖ using the combinational logic circuit 402, said input bits then being supplied to the post-processing logic circuit 403.

In the case of the approach from FIG. 3 (concatenation), k=n. The robustness level is at its lowest here, but performance, i.e., the throughput at which the final random numbers are produced, is at the maximum with this approach.

In the case of the approach from FIG. 2 (XORing), k=m. The robustness level is at its highest with this approach. Performance is at its lowest, however.

To be able to compare performance values for different approaches and parameter values with one another, the throughput (i.e., the rate) at which the final random numbers are produced when using the approach from FIG. 2 is defined as 100% performance below. This is simultaneously the performance that a random number generator having identical post-processing but only one physical noise source would have.

An embodiment in which the final random numbers are generated twice as fast as 200% performance, for example.

For values of k where m<k<n, the robustness level (and performance) assumes a value between the extremes in the approach from FIGS. 2 and 3. The greater the robustness, the lower the performance (and vice versa).

An example that is considered is a random number generator 400 that contains 12 noise sources 401, each of which generates a noise bit with 0.5-bit entropy per CPU clock to cycle, i.e., the generated raw data contain 50% entropy. The final random numbers are meant to contain at least 0.997-bit entropy per bit. The post-processing logic circuit 403 uses the compression rate 10:1.

In this case, therefore, q=12, m=1 and n=mq=12.

For k=n=12 (FIG. 3, i.e. concatenation), the robustness level is b=0 and performance is 1200%.

For k=6, the robustness level is b=3 and performance is 600% (when using an optimum combinational logic circuit). That is to say that even if one, two or three of the total of 12 noise sources fail, the final random numbers still contain over 99.7% entropy.

For k=4, the robustness level is b=5 and performance is 400%.

For k=2, the robustness level is b=7 and performance is 200%.

For k=m=1 (FIG. 2, i.e. XORing), the robustness level is b=11. And performance (as stipulated above) is 100%.

If the parameters q, m and k are predefined, the question arises as to how the outputs from the q noise sources 401, which supply a total of n=mq noise bits per unit time, can best be combined with one another, i.e. how a k-bit vector E=(E₁, . . . , Eₖ) can be formed from the n noise bits R₁, . . . , Rₙ so that the random vector E has as high an entropy as possible. A combinational logic circuit 402 having this property—that is to say for which the entropy in the random vector E assumes the maximum possible value—is referred to as “optimum” below.

According to various embodiments, a random number generator 400 having multiple noise sources 401 combines said outputs with one another in accordance with an optimum combinational logic circuit such as this.

The optimality of the combinational logic circuit in this case relates to a model in which the n noise bits R₁, . . . , Rₙ are assumed to be statistically independent. If the noise bits are furthermore also identically distributed, then the so-called i.i.d. case is present. (“i.i.d.” stands for independent and identically distributed.) The i.i.d. case is thus included as a special case in the model assumed here. The model assumption of statistical independence is fulfilled exactly for some random number generators and in a good approximation for other random number generators. For random number generators containing physical noise sources for which the bits in the generated m-bit word have high dependencies, the combinational logic units that are optimum in this context may not be the best possible choice for maximizing entropy. Such random number generators require a separate analysis.

Based on i.i.d. assumptions, it holds that: for the given n noise bits R=(R₁, . . . , Rₙ)^{T}, the combined vector E=(E₁, . . . , Eₖ)^{T} has maximum entropy when

E=M R

with a binary k×n matrix

$$M = \begin{matrix}{M}_{11} & {M}_{12} & … & {M}_{1 n} \\ {M}_{21} & {M}_{22} & … & {M}_{2 n} \\ … & … & … & … \\ {M}_{k 1} & {M}_{k 2} & … & {M}_{kn}\end{matrix}$$

of rank k that has the property that each of the 2^{k}−1 possible nontrivial (i.e., different from the null vector) linear combinations of the k rows of the matrix M has the highest possible number of ones.

By way of example, let q=4, m=2 and k=4. The random number generator 400 thus has four independently operating noise sources 401 (noise source #1 to noise source #4). Each individual noise source 401 generates one 2-bit word per CPU dock cycle (m=2), which means that a total of eight noise bits R₁, . . . , R₈ are generated per CPU clock cycle (n=8). Noise source #1 is assumed to generate the random word (R₁, R₂), noise source #2 is assumed to generate the random word (R₃, R₄), noise source #3 is assumed to generate the random word (R₅, R₆) and noise source #4 is assumed to generate the random word (R₇, R₈).

The combinational logic circuit 402 calculates a k=4-bit input vector E=(E₁,E₂,E₃,E₄) from the eight noise bits.

An optimum (in the above sense) combinational logic circuit 402 is provided by the following 4×8 matrix M_{8,4,4}:

$${M}_{8 , 4 , 4} = \begin{matrix}1 & 0 & 0 & 1 & 0 & 1 & 1 & 0 \\ 0 & 1 & 0 & 1 & 1 & 1 & 0 & 0 \\ 0 & 0 & 1 & 0 & 1 & 1 & 1 & 0 \\ 0 & 0 & 0 & 1 & 1 & 0 & 1 & 1\end{matrix}$$

It therefore holds that:

E₁=R₁⊕R₄⊕R₆⊕R₇.

E₂=R₂⊕R₄⊕R₅⊕R₆,

E₃=R₃⊕R₅⊕R₆⊕R₇,

E₄=R₄⊕R₅⊕R₇⊕R₈.

The four rows of the matrix M_{8,4,4} are denoted by A, B, C and D. The 15 nontrivial linear combinations of the four rows of the matrix M_{8,4,4} are then provided by

### A=(10010110), B=(01011100), C=(00101110), D=(00011011), A⊕B=(11001010), A⊕C=(10111000),

### A⊕D=(10001101), B⊕C=(01110010), B⊕D=(01000111), C⊕D=(00110101),

A⊕B⊕C=(11100100), a⊕B⊕D=(11010001), A⊕C⊕D=(10100011), B⊕C⊕D=(01101001),

### A⊕B⊕C⊕D=(11111111).

The first fourteen linear combinations each contain four ones and the last linear combination contains eight ones. The number of four ones is thus never undershot.

The matrix M_{8,4,4} is the generator matrix of a linear code of length n=8, dimension k=4 and minimum distance d=4, a so-called linear (8, 4, 4) code. This is the first-order Reed-Muller code of length 8.

Here, the noise bit vector R is thus processed to produce the processed noise bit vector E in accordance with its multiplication from the right by a generator matrix of a linear code. The multiplication of the noise bit vector from the right by a generator matrix means, as in the formula above, that the generator matrix is on the left in the multiplication and the noise bit vector is on the right, i.e. the noise bit vector from the right is multiplied by the generator matrix.

The processing of the noise bit vector in accordance with this multiplication can also be regarded as syndrome calculation for the noise bit vector for the dual code relating to the linear code.

The matrix M_{8,4,4} is the best possible in the sense that among the 2³² binary 4×8 matrices that exist there is no matrix that contains more than four ones in each row and in all nontrivial linear combinations of the rows. The asserted optimality of the combinational logic circuit defined by the matrix M_{8,4,4} is derived from this. The matrix M_{8,4,4} is not determined uniquely, however. There are multiple (mutually equivalent) 4×8 matrices that likewise contain at least four ones in each of the 15 nontrivial linear combinations of matrix rows. Equivalent, matrices likewise define optimum combinational logic circuits.

In the examples below, the random number generator 400 is again assumed to contain 12 noise sources 401 generating one bit having 0.5-bit entropy per CPU clock cycle, a post-processing logic circuit 403 that transforms inputs having 50% entropy into a random number having at least 99.7% entropy, and a combinational logic circuit 402 that converts the 12 noise bits R₁, . . . , R₁₂ into k input bits E₁, . . . , Eₖ.

Optimum combinational logic circuits are cited for the values k=12, 6, 4, 2, 1.

Case k=12:

This is the case from FIG. 3 (direct parallel input of the 12 noise bits into the post-processing algorithm 403).

The combinational logic circuit is the 12×12 identity matrix I₁₂.

$${M}_{12 , 12 , 1} = \begin{matrix}1 & 0 & 0 & 0 & 0 & 0 & 0 & 0 & 0 & 0 & 0 & 0 \\ 0 & 1 & 0 & 0 & 0 & 0 & 0 & 0 & 0 & 0 & 0 & 0 \\ 0 & 0 & 1 & 0 & 0 & 0 & 0 & 0 & 0 & 0 & 0 & 0 \\ 0 & 0 & 0 & 1 & 0 & 0 & 0 & 0 & 0 & 0 & 0 & 0 \\ 0 & 0 & 0 & 0 & 1 & 0 & 0 & 0 & 0 & 0 & 0 & 0 \\ 0 & 0 & 0 & 0 & 0 & 1 & 0 & 0 & 0 & 0 & 0 & 0 \\ 0 & 0 & 0 & 0 & 0 & 0 & 1 & 0 & 0 & 0 & 0 & 0 \\ 0 & 0 & 0 & 0 & 0 & 0 & 0 & 1 & 0 & 0 & 0 & 0 \\ 0 & 0 & 0 & 0 & 0 & 0 & 0 & 0 & 1 & 0 & 0 & 0 \\ 0 & 0 & 0 & 0 & 0 & 0 & 0 & 0 & 0 & 1 & 0 & 0 \\ 0 & 0 & 0 & 0 & 0 & 0 & 0 & 0 & 0 & 0 & 1 & 0 \\ 0 & 0 & 0 & 0 & 0 & 0 & 0 & 0 & 0 & 0 & 0 & 1\end{matrix}$$

A random number generator 400 containing this combinational logic circuit has the robustness level b=0 (when the compression rate 10:1 is used in the post-processing algorithm).

Case k=6:

An optimum combinational circuit is provided by the following matrix:

$${M}_{12 , 6 , 4} = \begin{matrix}1 & 0 & 0 & 0 & 0 & 0 & 1 & 1 & 1 & 0 & 0 & 0 \\ 0 & 1 & 0 & 0 & 0 & 0 & 0 & 1 & 1 & 1 & 0 & 0 \\ 0 & 0 & 1 & 0 & 0 & 0 & 0 & 0 & 1 & 1 & 1 & 0 \\ 0 & 0 & 0 & 1 & 0 & 0 & 0 & 0 & 0 & 1 & 1 & 1 \\ 0 & 0 & 0 & 0 & 1 & 0 & 1 & 0 & 0 & 0 & 1 & 1 \\ 0 & 0 & 0 & 0 & 0 & 1 & 1 & 1 & 0 & 0 & 0 & 1\end{matrix}$$

A random number generator 400 containing this combinational logic circuit has robustness b=3 (for the compression rate 10:1 used).

The robustness level 3 can be read off from the matrix M_{12,6,4} as follows. If three (random) noise sources fail, then the associated three columns would be removed from the matrix M_{12,6,4}. A new matrix now having only nine columns is produced. Each row of the new matrix still contains a 1. The new matrix describes the (new) combinational logic circuit for the (degenerate) random number generator having the three failed noise sources. Since each row of the new matrix still contains at least one 1 and each of the 63 nontrivial linear combinations of matrix rows likewise still contains at least one 1, the required entropy content of at least 99.7% in the final random numbers is still achieved (for the compression rate 10:1). This is no longer guaranteed if the new matrix contains a row of zeros. This case arises for example if the first, seventh, eighth and ninth noise source fail simultaneously. The first row of the new matrix would then be identical to the all-zero row. The random number generator thus does not have the robustness level 4.

Case k=4:

An optimum combinational logic circuit is provided by the following matrix:

$${M}_{12 , 4 , 6} = \begin{matrix}1 & 0 & 0 & 0 & 1 & 1 & 0 & 1 & 1 & 1 & 0 & 0 \\ 0 & 1 & 0 & 0 & 1 & 1 & 1 & 1 & 0 & 0 & 0 & 1 \\ 0 & 0 & 1 & 0 & 0 & 0 & 1 & 1 & 1 & 0 & 1 & 1 \\ 0 & 0 & 0 & 1 & 1 & 0 & 0 & 1 & 0 & 1 & 1 & 1\end{matrix}$$

A random number generator 400 containing this combinational logic circuit has robustness b=5.

Case k=2:

An optimum combinational logic circuit is provided by the following matrix:

$${M}_{12 , 2 , 8} = \begin{matrix}1 & 0 & 1 & 1 & 0 & 1 & 1 & 0 & 1 & 1 & 0 & 1 \\ 0 & 1 & 1 & 0 & 1 & 1 & 0 & 1 & 1 & 0 & 1 & 1\end{matrix}$$

A random number generator 400 containing this combinational logic circuit has robustness b=7.

Case k=1:

This is the XORing from FIG. 2.

The associated (and optimum) combinational logic circuit is provided by the following matrix:

M_{12,1,12}=1 1 1 1 1 1 1 1 1 1 1 1

A random number generator 400 containing this combinational logic circuit has robustness b=11.

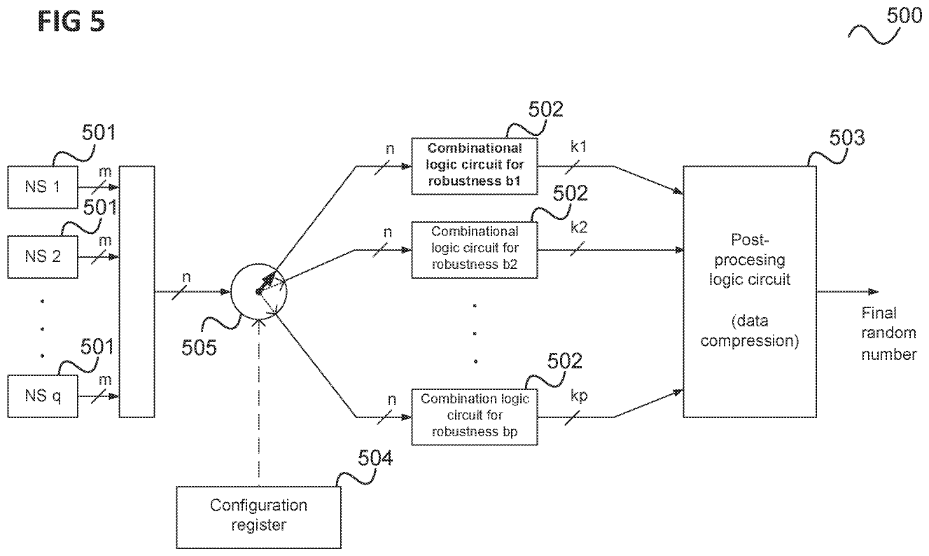

FIG. 5 shows a random number generator 500 having an adjustable robustness level.

Like the random number generator 400, the random number generator 500 has q≥2 physical noise sources 501 (NS) and a post-processing logic circuit 503.

However, in contrast to the random number generator 400, the random number generator 500 has multiple (e.g., optimum) combinational logic circuits 503, each combinational logic circuit implementing a respective robustness level, for example by operating in accordance with one of the aforementioned matrices for a respective robustness level.

As in the case of the random number generator 400, each noise source generates m≥1 noise bits per unit time. A total of n=mq noise bits are therefore generated per unit time.

A configuration register 504 is used to adjust the desired robustness level (e.g., in accordance with a parameter that is set by a user by means of a user input). The noise bits are then subsequently processed using the combinational logic circuit that has the adjusted robustness level by virtue of their being forwarded to this combinational logic circuit by a distribution circuit (e.g., a multiplexer) 505.

By way of example, the robustness level can be adjusted depending on the legal situation in the region in which the processing device containing the random number generator is meant to be used.

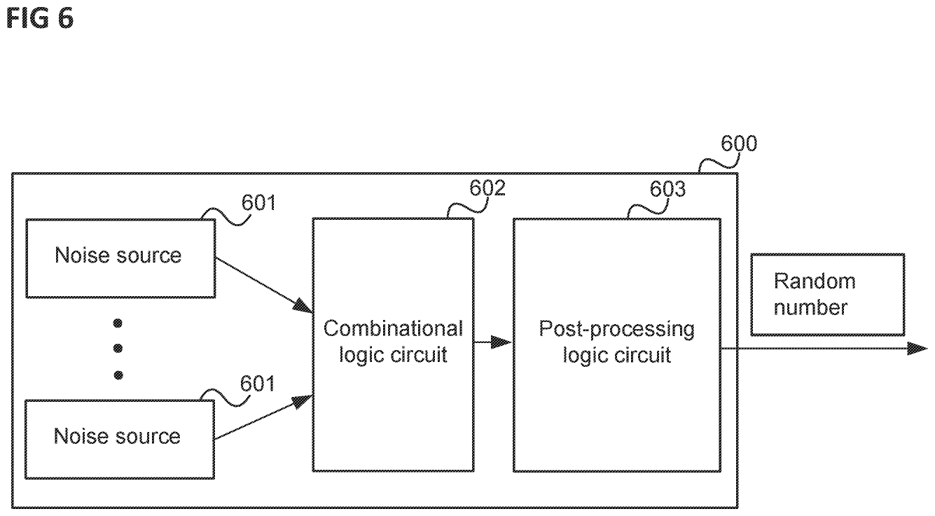

In summary, according to various embodiments, an integrated circuit as shown in FIG. 6 is provided.

FIG. 6 shows an integrated circuit 600 according to one embodiment.

The integrated circuit 600 comprises multiple noise sources 601, each noise source being configured to output a respective set of noise bits for a random vector.

The integrated circuit 600 further comprises a combinational logic circuit 602 configured to process a noise bit vector, corresponding to a concatenation of the bits of the sets of noise bits, in accordance with a multiplication by a matrix to produce a processed noise bit vector, with the result that the processed noise bit vector comprises more bits than each of the sets of noise bits and comprises fewer bits than the noise bit vector.

The integrated circuit 600 also comprises a post-processing logic circuit 603 configured to generate the random vector from the processed noise bit vector.

In other words, according to various embodiments, a noise bit vector (containing all the noise bits) is compressed, but not to the extent that it now has only as many bits as are provided (per unit time) by one noise source. The former ensures that the entropy is increased (that is to say that the processed noise bit vector has a higher entropy than the sets of noise bits) and the latter ensures that the rate at which random vectors are generated is higher than if a single noise source is used (or all sets of noise bits are simply XORed). The compression means that the matrix is not a permutation matrix, i.e. permutation matrices (in particular, the identity matrix) are excluded.

Using the designations from the exemplary embodiments above, the processed noise bit vector has the length k (in bits), the sets of noise bits each have the length m and it holds that k>m and k<mq (where q is the number of noise sources). The noise bit vector is the concatenation of the bits of the sets of noise bits (e.g. according to a stipulated order of the sets of noise bits, e.g. according to a numbering of the noise sources). The concatenation can also involve permutation in this case, i.e. the bits can be scrambled. By way of example, the noise bit vector receives a bit from the first set of noise bits, then a bit from the second set of noise bits, etc., then the second bit from the first set of noise bits, then the second bit from the second set of noise bits, etc. This should not be restricted here. Concatenation therefore means joining together the bits in any permutation (without combining the bits). Alternatively, the concatenation can be understood as consecutive concatenation and the permutation is ascribed to the combination (e.g. as preprocessing). The noise sources are physical noise sources (e.g. digital noise generators or noise sources on the basis of analog noise sources, the outputs from which are digitized, e.g. thermal noise sources or on the basis of diodes).

Selection of k allows the robustness (e.g. in accordance with the above value b) or performance of the random number generation to be adjusted.

The random vector is a vector of values (i.e. a binary vector) and can also be regarded as a random number (e.g. by interpreting it as a binary value). Conversely, a random number can also be regarded as a random vector (based on a representation of the random number as a vector of bits, for example).

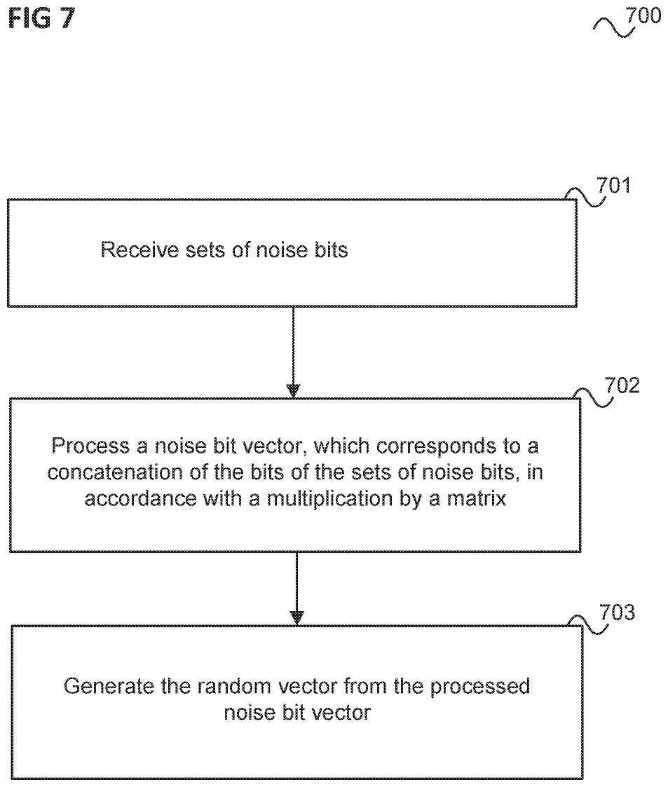

According to various embodiments, a method as shown in FIG. 7 is carried out.

FIG. 7 shows a flowchart 700 that illustrates a method for generating a random vector.

In 701, a respective set of noise bits is received from each noise source of multiple noise sources.

In 702, a noise bit vector, corresponding to a concatenation of the bits of the sets of noise bits, is processed in accordance with a multiplication by a matrix to produce a processed noise bit vector, with the result that the processed noise bit vector comprises more bits than each of the sets of noise bits and comprises fewer bits than the noise bit vector.

In 703, the random vector is generated from the processed noise bit vector.

Various exemplary embodiments are cited below.

In Exemplary embodiment 1 is an integrated circuit as described with reference to FIG. 6.

Exemplary embodiment 2 is an integrated circuit based on exemplary embodiment 1, wherein the post-processing logic circuit is configured to generate the random vector by compressing the processed noise bit vector.

Exemplary embodiment 3 is an integrated circuit based on exemplary embodiment 1 or 2, comprising a concatenation circuit configured to generate the noise bit vector by concatenating the bits of the sets of noise bits.

Exemplary embodiment 4 is an integrated circuit based on one of exemplary embodiments 1 to 3, wherein the multiplication by the matrix is the multiplication of the noise bit vector from the right by a generator matrix of a linear code having a code length equal to the number of bits of the noise bit vector and a code dimension equal to the number of bits of the processed noise bit vector.

Exemplary embodiment 5 is an integrated circuit based on exemplary embodiment 4, wherein the linear code is a linear code with the greatest possible minimum distance among the linear codes having the code length and the code dimension.

Exemplary embodiment 6 is an integrated circuit based on one of exemplary embodiments 1 to 5, comprising at least one further combinational logic circuit, each combinational logic circuit from the combinational logic circuit and the at least one further combinational logic circuit being configured so as, when supplied with the noise bit vector, to process the noise bit vector to produce a respective processed noise bit vector, and a selection logic circuit configured to select one combinational logic circuit from the combinational logic circuit and the at least one further combinational logic circuit and to supply the selected combinational logic circuit with the noise bit vector, the post-processing logic circuit being configured to generate the random vector from the noise bit vector processed by the selected combinational logic circuit.

Exemplary embodiment 7 is an integrated circuit based on exemplary embodiment 6, wherein the selection logic circuit is configured to select the combinational logic circuit in accordance with a predefined parameter.

Exemplary embodiment 8 is an integrated circuit based on one of exemplary embodiments 1 to 7, further comprising a processor configured to take the random vector as a basis for performing a cryptographic operation.

Exemplary embodiment 9 is an integrated circuit based on one of exemplary embodiments 1 to 8, wherein at least some of the noise sources are of different design.

One possible design for a noise source consists of two ring oscillators having different speeds, the phase differences of said ring oscillators being continually digitized. The randomness is based on the phase noise.

Another design exploits the metastability of a flipflop. So that the state of a flipflop can change (from a logic zero to a logic one or vice versa), the input signal needs to exceed a specific threshold value. The strength of the input signal is deliberately kept permanently close to this threshold value. The state of the flipflop is then undefined, and a random sequence of zeros and ones appears at the output of the flipflop.

Exemplary embodiment 10 is a method for generating a random vector as described with reference to FIG. 7.

Exemplary embodiment 11 is a method based on exemplary embodiment 10, wherein the multiplication by the matrix is the multiplication of the noise bit vector from the right by a generator matrix of a linear code having a code length equal to the number of bits of the noise bit vector and a code dimension equal to the number of bits of the processed noise bit vector.

Exemplary embodiment 12 is a method based on exemplary embodiment 11, comprising stipulating a robustness of the generation of the random vector and ascertaining the code dimension, with the result that a linear code having a code length equal to the number of bits of the noise bit vector and the ascertained code dimension exists that has a minimum distance, with the result that the stipulated robustness is fulfilled, and processing the noise bit vector to produce the processed noise bit vector in accordance with a multiplication of the noise bit vector from the right by a generator matrix of the linear code.

Embodiments described in connection with the integrated circuit apply to the method for generating a random vector analogously, and vice versa.

Although the invention has been shown and described primarily with reference to specific embodiments, it should be understood by those familiar with the technical field that numerous modifications can be made with regard to configuration and details thereof, without departing from the essence and scope of the invention as defined by the claims hereinafter. The scope of the invention is therefore determined by the appended claims, and the intention is for all modifications to be encompassed which come under the literal meaning or the scope of equivalence of the claims.

1. An integrated circuit, comprising:
multiple noise sources, each noise source being configured to output a respective set of noise bits for a random vector,
a combinational logic circuit configured to process a noise bit vector, corresponding to a concatenation of the bits of the sets of noise bits, in accordance with a multiplication by a matrix to produce a processed noise bit vector, with the result that the processed noise bit vector comprises more bits than each of the sets of noise bits and comprises fewer bits than the noise bit vector; and
a post-processing logic circuit configured to generate the random vector from the processed noise bit vector.

2. The integrated circuit of claim 1, wherein the post--processing logic circuit is configured to generate the random vector by compressing the processed noise bit vector.

3. The integrated circuit of claim 1, comprising a concatenation circuit configured to generate the noise bit vector by concatenating the bits of the sets of noise bits.

4. The integrated circuit of claim 1, wherein the multiplication by the matrix is the multiplication of the noise bit vector from the right by a generator matrix of a linear code having a code length equal to the number of bits of the noise bit vector and a code dimension equal to the number of bits of the processed noise bit vector.

5. The integrated circuit of claim 4, wherein the linear code is a linear code with the greatest possible minimum distance among the linear codes having the code length and the code dimension.

6. The integrated circuit of claim 1, comprising at least one further combinational logic circuit, each combinational logic circuit from the combinational logic circuit and the at least one further combinational logic circuit being configured so as, when supplied with the noise bit vector, to process the noise bit vector to produce a respective processed. noise bit vector, and a selection logic circuit configured to select one combinational logic circuit from the combinational logic circuit and the at least one further combinational logic circuit and to supply the selected combinational logic circuit with the noise bit vector, the post-processing logic circuit being configured to generate the random vector from the noise bit vector processed by the selected combinational logic circuit.

7. The integrated circuit of claim 6, wherein the selection logic circuit is configured to select the combinational logic circuit in accordance with a predefined parameter.

8. The integrated circuit of claim 1, further comprising a processor configured to take the random vector as a basis for performing a cryptographic operation.

9. The integrated circuit of claim wherein at least some of the noise sources are of different design.

10. A method for generating a random vector, comprising:
receiving a respective set of noise bits from each noise source of multiple noise sources;
processing a noise bit vector, corresponding to a concatenation of the bits of the sets of noise bits, in accordance with a multiplication by a matrix to produce a processed noise bit vector, with the result that the processed noise bit vector comprises more bits than each of the sets of noise bits and comprises fewer bits than the noise bit vector; and
generating the random vector from the processed noise bit vector.

11. The method of claim 10, wherein the multiplication by the matrix is the multiplication of the noise bit vector from the right by a generator matrix of a linear code having a code length equal to the number of bits of the noise bit vector and a code dimension equal to the number of bits of the processed noise bit vector.

12. The method of claim 11, comprising stipulating a robustness of the generation of the random vector and ascertaining the code dimension, with the result that a linear code having a code length equal to the number of bits of the noise bit vector and the ascertained code dimension exists that has a minimum distance, with the result that the stipulated robustness is fulfilled, and processing the noise bit vector to produce the processed noise bit vector in accordance with a multiplication of the noise bit vector from the right by a generator matrix of the linear code.
